(19) United States
(12) Patent Application Publication
(10) Pub. No.: US 2013/0222254 A1
(43) Pub. Date: Aug. 29, 2013

(54) Smart keyboard for computer and compact devices

(71) Applicants: Yu Tang, Beijing (CN); Peter G. Liu, San Diego, CA (US)

(72) Inventors: Yu Tang, Beijing (CN); Peter G. Liu, San Diego, CA (US)

(73) Assignee: Crescendo Tech Services, San Diegoq, CA (US)

(21) Appl. No.: 13/440,685

(22) Filed: Apr. 5, 2012

(30) Foreign Application Priority Data
Feb. 29, 2012 (CN) 201210047913.X

(51) Int. Cl. G06F 3/02

(52) U.S. Cl. 345/169

(57) ABSTRACT

This document proposes a new type of keyboard concept, Smart Keyboard, which creates a compact keyboard that can make the overall size of the keyboard smaller. It also makes it more efficient for text input on computer or other compact electronic devices, such as notebooks, tablets or even smart phones and game devices.

### FIELD OF THE INVENTION

This invention relates in general to the field of electronic devices, and more specifically, to an accessory for entering text data in an electronic device such as computer, notebook, tablet and smart phone, etc.

### BACKGROUND OF THE INVENTION

The current keyboards can be categorized in a few different types. They are,
Full-Size Keyboard: A typewriter type of keyboard commonly used for Computers.
Full Keyboard: Thumb-Type QWERTY Keyboard commonly used on some Smart Phone, such as Blackberry.
Condensed Keyboard: Each physical key has two letters and depressing the key twice in rapid succession enters the second letter.
Numeric Keypad: A standard phone keypad has alphabetic letters on the numeric keys; for example, the key “1” is also “ABC.” In text mode, the appropriate letters are entered by pressing a key once or several times in rapid succession. With each key press, providing it is done quickly, the next letter in sequence becomes available.
Virtual Keyboard: A full QWERTY keyboard is presented on a touch screen.

The Full Size Keyboard is big and normally suitable for office/stationary usage. Other thumb-typing keyboards are not very convenient due to their small size and the need of multi-strike input and single finger operation. It limits the typing speed significantly. With the rapid growing trend of portable smart devices become more and more popular, a compact keyboard, which is fully compatible with the conventional typing skill as well as with comfortable typing space, will make the text typing more fun and efficient for portable devices, such as tablet PC, Panel PC and smart phones.

### SUMMARY OF THE INVENTION

This invention provides a possible solution for a compact keyboard which is closely patterned to meet the conventional typing. It solves the problems associated with the Condensed Keyboard and Numeric Keypad. It will provide users with better typing experience such as, comfort size for keys, faster typing with similar conventional typing skills. The last but not the least, it makes it possible to design the keyboard in a more ecologic layout for human-beings.

### BRIEF DESCRIPTION OF THE FIGURES

FIG. 1, Illustrates a layout for the Smart Keyboard.

FIG. 2, Illustrates the Vertical Configuration of the Smart Keyboard.

FIG. 3, Illustrates a Concept of Split-Smart-Keyboard.

FIG. 4, Integrates a concept of an Ego-Configuration of the Smart Keyboard on a Portable Device.

### DETAILED DESCRIPTION OF THE INVENTION

This invention proposes a new concept of keyboard layout. It defines the Finger Keys, with multiple characters, and Thumb Keys, to determine the choice of the characters.

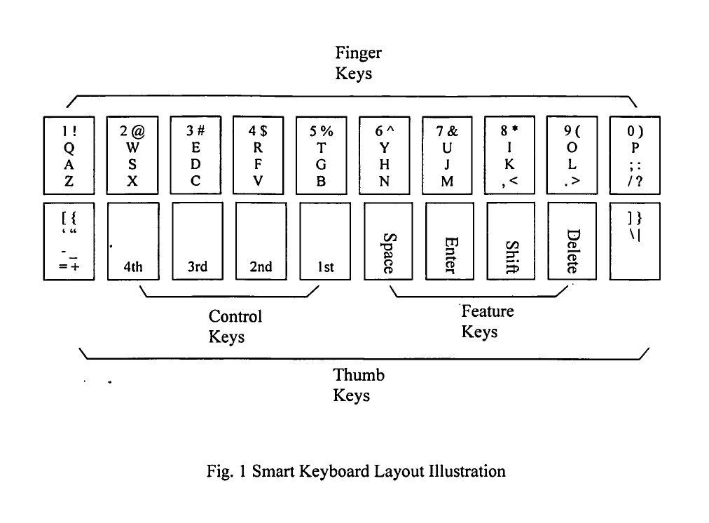

Here is an illustration of one of the possible implementations (see FIG. 1).

1. Keys are grouped into “Finger-Keys” and “Thumb-Keys”.

2. Finger-Keys are combo keys of each column on the conventional QWERTY keyboard.

3. Thumb-Keys are Control Keys, Feature Keys and Miscellaneous Keys.
The Control Keys will determine the row number of the Finger-Key strike.
The Feature Keys are for “Space-Bar”, “Enter”, “Shift” and “Del”.
The Miscellaneous Keys are for special characters.

Giving an example: when user tries to type the letter of “g”, he/she uses Thumb-Key to set “2^{nd}” (2^{nd} Row from bottom), and then use Finger-Key to type “5% TGB” key. For capital case, use “Shift” key.

With this Smart Keyboard design, the Full-Size Keyboard can be replaced with two rows of keys. The overall size of the keyboard will be a much smaller and compact package, while key size could be relatively larger to fit human's hands for user with comfortable typing experience.

This Smart Keyboard can be named as “ZAQ1” (pronounced as “Zack One”), which are the letters of the first Finger Key read from the bottom.

The implementation of the Smart Keyboard could be similar to the conventional Full-size Keyboard as illustrated in FIG. 1.

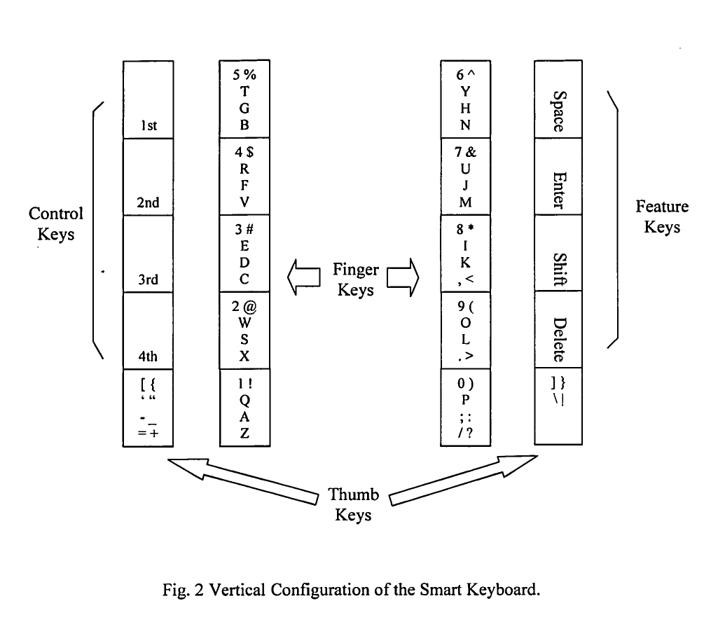

It is also possible to rearrange in different patterns. For example, the keys can be configured in vertical pattern. FIG. 2 illustrates one possible layout.

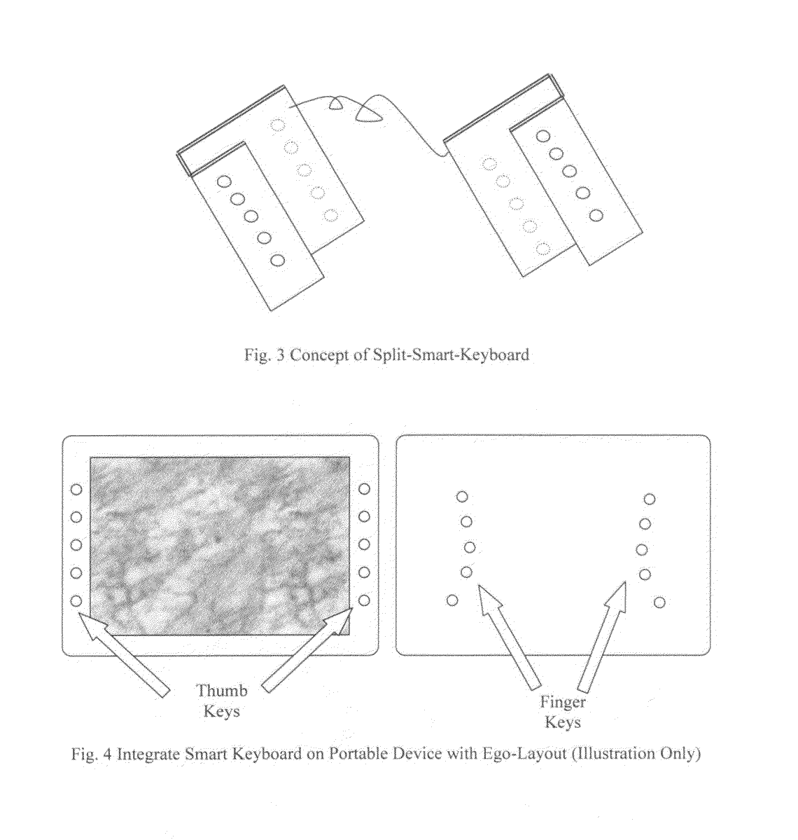

FIG. 3 shows an implementation of the vertical configuration with Split-Smart-Keyboard.

FIG. 4 further illustrates a possible ecologic integration of the Smart Keyboard on a portable device.

What is claimed of proprietary invention is:

1. The Smart Keyboard composes two groups of keys, Finger Keys and Thumb Keys.

2. The Finger Keys are combo-keys which group the conventional QWERTY keyboard in its column pattern.

3. The Thumb Keys are those miscellaneous characters and Control Keys which will be used to determine the character to be typed.

4. The Smart Keyboard has been named as “ZAQ1” (pronounced as “Zack One”), which is one of its Finger Keys. Other naming of the keyboard with the concept of claims 1, 2 and 3, is under the scope of this invention.

5. Any re-arrangement of the layout of the keys with the concept of the claims 1, 2, and 3, is under the scope of this invention.

6. Any re-assignment of the keys with the concept of the claims 1, 2 and 3, is under the scope of this invention.

7. Any implementation of a keyboard, with the concept of the claims 1, 2 and 3, is under the scope of this invention; no matter it is a Hardware Product or a Software Solution (such as soft keyboard on touch screen products).
